(19) United States
(12) Patent Application Publication
(10) Pub. No.: US 2018/0367540 A1
(43) Pub. Date: Dec. 20, 2018

(54) CONTROLLING ACCESS TO CONTENT

(71) Applicant: Wickr Inc., San Francisco, CA (US)

(72) Inventor: Darlene Miranda, West Orange, NJ (US)

(21) Appl. No.: 15/331,728

(22) Filed: Oct. 21, 2016

(51) Int. Cl. H04L 29/06; H04L 9/08

(52) U.S. Cl. CPC H04L 63/101; H04L 9/0822; H04L 63/061

(57) ABSTRACT

The present disclosure describes a system, method, and non-transitory computer readable medium that secures communications based upon a permission level associated with the content of the communication, a receiver's device, and a receiver's instantiation of a secure collaboration app. This approach effectively binds the communication to a permission level and a combination of the receiver's device and application, thereby ensuring only authorized users are able to decrypt and access the content of the communication.

### BACKGROUND OF THE INVENTION

Transmitting information to unauthorized users, either inadvertently or maliciously, is a major business concern for enterprises today. In order to combat the disclosure of sensitive information, several solutions have been proposed, each of which suffers from its own shortcomings. For example, encrypting a communication before transmission may prevent unauthorized users from accessing it. However, users share credentials or use weak encryption and/or keys, which allow unauthorized users to access the content of the communication. Moreover, data loss prevention systems merely record users' communications, allowing administrators to detect and mitigate disclosures of sensitive and confidential information after the communication has been shared with an unauthorized user.

### BRIEF DESCRIPTION OF THE DRAWINGS

Various embodiments of the invention are disclosed in the following detailed description and the accompanying drawings.

FIG. 1 illustrates an embodiment of an environment in which the exchange of secure communications is facilitated by a security platform.

FIG. 2 illustrates a client device that transmits and receives encrypted communications using a secure collaboration application.

FIG. 3 illustrates a process for transmitting encrypted communications according to a first embodiment.

FIG. 4 illustrates a process for receiving and decrypting encrypted communications according to a first embodiment.

FIG. 5 illustrates a process for transmitting encrypted communications according to a second embodiment.

FIG. 6 illustrates a process for receiving and decrypting encrypted communications according to a second embodiment.

FIG. 7 illustrates a process for transmitting encrypted communications according to another embodiment of the disclosure.

FIG. 8 illustrates a process for receiving and decrypting encrypted communications according to another embodiment.

FIG. 9 shows an interface for exchanging encrypted communications according to an embodiment of the disclosure.

### DETAILED DESCRIPTION

The present disclosure describes a system, method, and computer-readable medium that controls access to communications such that recipients that do not rise to the assigned permission level cannot decrypt or access the transmitted communication. The present disclosure represents an improvement over prior art systems by tying the encryption used to secure the communication to a minimum permission level, a receiver's device, and a receiver's instantiation of a secure collaboration application (“app”). This approach effectively binds the communication to a permission level and a combination of the receiver's device and application.

According to a first example, a method begins on a sending device when a user begins composing a communication to one or more receiver through a secure collaboration app. Next, the user assigns a permission level to the communication that defines permissions needed access the communication. After the permission level is assigned to the communication, the secure collaboration app generates a first encryption key and encrypts the communication and the permission level using the first encryption key. Once the communication and permission level are encrypted, the secure collaboration app generates at least one key-encrypting key for each of the one or more receivers. The key-encrypting key is derived according to a key agreement protocol using ephemeral information from a sender and each of the receivers. Next, the secure collaboration app encrypts the first encryption key for each receiver and encapsulates the encrypted communication, the encrypted permission level, and the encrypted first encryption key in a secure communication container. After the secure communication container is assembled, the user's secure collaboration app transmits the secure communication container to the receivers.

In some examples, the communication prepared by the user is a secure file transfer and the permission level is assigned by a third party server in accordance with a permission level associated with the file being transferred. Accordingly, the user's secure collaboration app transmits a request to a third party server for the permission level for the communication and receives a response from the third party server that includes the permission level.

Another example describes a system that includes a processor and memory. The memory stores instructions, that enable the processor to assign a permission level to a communication that defines permissions needed access the communication. After the permission level is assigned to the communication, the processor generates a first encryption key and encrypts the communication and the permission level using the first encryption key. Once the communication and permission level are encrypted, the processor generates at least one key-encrypting key for each of the receivers. The key-encrypting key is derived according to a key agreement protocol using ephemeral information from a sender and each of the receivers. Next, the processor encrypts the first encryption key for each receiver and encapsulates the encrypted communication, the encrypted permission level, and the encrypted first encryption key in a secure communication container. After the secure communication container is assembled, the processor transmits the secure communication container to the receivers.

Another example describes a non-transitory computer-readable medium that includes instructions for assigning a permission level to a communication. The permission level that defines permissions needed by the receiver to access the communication. The non-transitory computer-readable medium also includes instructions for generating a first encryption key, which is used to encrypt the communication and the permission level. The instructions include generating a key-encrypting key for each that is used to encrypt the first encryption key. Finally, the instructions include encapsulating the encrypted communication, the encrypted permission level, and the encrypted first encryption key in a secure communication container and transmitting the secure communication container to the receivers.

Yet another example describes a method that includes a receiver receiving a secure communication container from a sender. The secure communication container includes an encrypted communication, an encrypted permission level, and an encrypted first encryption key. The receiver derives a key-encrypting key from ephemeral information that it already has and ephemeral information provided by the sender. Next, the receiver decrypts the encrypted first encryption key using the derived key-encrypting key. Then, the receiver decrypts the permission level using the decrypted first encryption key. Accordingly, the receiver's device compares the receiving device's permission level to the decrypted permission level to determine whether the receiver has permission to access the communication. If so, the receiver's secure collaboration app decrypts the encrypted communication. If not, the receiver's secure collaboration app discards it so the receiver cannot access the content of the communication.

Another example includes a system that includes a processor and a memory for storing instructions that are executed by the processor to receive a secure communication container that includes an encrypted communication, an encrypted permission level, and an encrypted first encryption key. Next, the instructions instruct the processor to derive a key-encrypting key from ephemeral information that it already has and ephemeral information provided by the sender and decrypt the encrypted first encryption key using the derived key-encrypting key. The processor is then configured to decrypt the permission level using the decrypted first encryption key and compare the receiving device's permission level to the decrypted permission level to determine whether the receiver has permission to access the communication. If so, the processor is configured to decrypt the encrypted communication and provide it to the receiver. If not, processor is configured to discard the communication so the receiver cannot access the content of the communication.

According to another example, a non-transitory computer-readable medium is provided that includes instructions to receive a secure communication container that includes an encrypted communication, an encrypted permission level, and an encrypted first encryption key. Next, the instructions include deriving a key-encrypting key from ephemeral information that it already has and ephemeral information provided by the sender and decrypting the encrypted first encryption key using the derived key-encrypting key. After obtaining the first encryption key, the instructions then include decrypting the permission level using the decrypted first encryption key and comparing the receiving device's permission level to the decrypted permission level to determine whether the receiver has permission to access the communication. If so, the instructions are configured to decrypt the encrypted communication and provide it to the receiver. If not, instructions are configured to discard the communication so the receiver cannot access the content of the communication.

One example of the present disclosure describes a method that includes a user composing a first communication on a secure collaboration app to one or more receivers. The method includes receiving an authorization key from a first server. Next, the user's secure collaboration app generates a first communication key that is used to encrypt the first communication. Next, the process generates a key-encrypting key for each receiver using ephemeral information from the sender and each receiver. The process then encrypts the first communication key with the key-encrypting key for each receiver and encrypts the encrypted first communication key with an authorization key to produce a twice-encrypted communication key. Finally, the process encapsulates the encrypted first communication and the twice-encrypted first communication key in a secure communication container and transmits it to each of the receivers.

Further to the example described above, the communication may be a secure file transfer. Accordingly, the user's secure collaboration app will obtain the authorization key from a document management system in accordance with the classification, or permission level, of the file. In other examples, the secure collaboration app obtains the authorization key from a data loss prevention system according to the content of the first communication.

Another example discloses a system that includes a processor and memory that includes instructions. The processor is configured to compose a first communication on a secure collaboration app to one or more receivers. The processor is further configured to receive an authorization key from a first server. Next, the processor is configured to generate a first communication key that is used to encrypt the first communication. Next, the processor is configured to generate a key-encrypting key for each receiver using ephemeral information from the sender and each receiver. The processor is configured to encrypt the first communication key with the key-encrypting key for each receiver and encrypt the encrypted first communication key with an authorization key to produce a twice-encrypted communication key. Finally, the processor is configured to encapsulate the encrypted first communication and the twice-encrypted first communication key in a secure communication container and transmit it to each of the receivers.

Yet another example of the present disclosure provides a non-transitory computer readable medium that includes instructions for composing a first communication on a secure collaboration app to one or more receivers. The instructions also include receiving an authorization key from a first server. Next, the instructions generate a first communication key that is used to encrypt the first communication and then generate a key-encrypting key for each receiver using ephemeral information from the sender and each receiver. Afterwards, the instructions encrypt the first communication key with the key-encrypting key for each receiver and encrypt the encrypted first communication key with an authorization key to produce a twice-encrypted communication key. Finally, the instructions encapsulate the encrypted first communication and the twice-encrypted first communication key in a secure communication container and transmit it to each of the receivers.

Another aspect of the disclosure includes a method that includes receiving, on a user's secure collaboration app, a secure communication container from a sender. The secure communication includes at least a first encrypted communication and a twice-encrypted first communication key. Next the method determines whether the user is capable of decrypting the twice-encrypted first communication key. If the user's secure collaboration app can decrypt the twice-encrypted first communication key, the process decrypts the twice-encrypted first communication key with an authorization key provided to the user by a first server. If, however, the process is unable to decrypt the twice-encrypted first key, the first encrypted communication is discarded and the process concludes. Next, the process derives a first key-encrypting key using ephemeral information that it has and ephemeral information from the sender. Next, the process decrypts the encrypted first communication key using the derived first key-encrypting key, and then decrypts the first encrypted communication using the decrypted first communication key. The method concludes with the decrypted first communication being provided to the user.

The present disclosure can be implemented in numerous ways, including as a process; an apparatus; a system; a composition of matter; a computer program product embodied on a non-transitory computer readable storage medium; and/or a processor, such as a processor configured to execute instructions stored on and/or provided by a memory coupled to the processor. These implementations, or any other form that the present disclosure may take, may be referred to as techniques. In general, the order of the steps of disclosed processes may be altered within the scope of the present disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the present disclosure is provided below along with accompanying figures that illustrate the principles of the present disclosure. The present disclosure is described in connection with such embodiments, but the present disclosure is not limited to any embodiment. The scope of the present disclosure is limited only by the claims and the present disclosure encompasses numerous alternatives, modifications, and equivalents. Numerous specific details are set forth in the following description in order to provide a thorough understanding of the present disclosure. These details are provided for the purpose of example and the present disclosure may be practiced according to the claims without some or all of these specific details. For the purpose of clarity, technical material that is known in the technical fields related to the present disclosure has not been described in detail so that the present disclosure is not unnecessarily obscured.

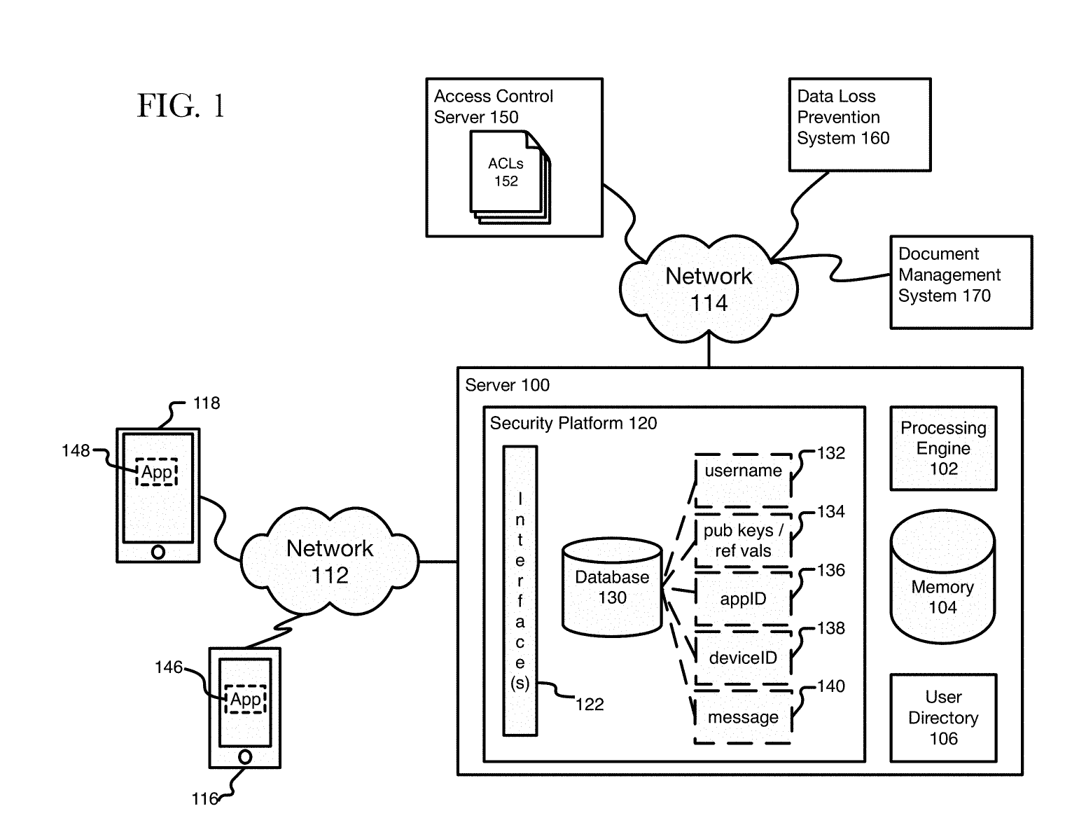

FIG. 1 illustrates an embodiment of an environment in which secure communications are exchanged. In particular, FIG. 1 illustrates a first client device 116 and a second client device 118 exchanging communications and information with each other via network 112 and security platform 120, which is located on server 100. Server 100 may be interconnected to access control server 150, data loss prevention (DLP) system 160, and document management system 170 through network 114.

According to the embodiments described herein, encrypted communications are exchanged using secure communication containers, which encapsulate a sender's communication data and control data. The secure communication container may also include information, such as encryption information, hardware binding information, message security controls, and decryption information—for multiple receivers (as applicable)—to securely travel with the message. The secure communication container also provides cross-platform support so that users may communicate regardless of their operating systems (e.g., Linux, iOS, and Windows), smart phone platforms (e.g., iPhone, Android, Windows, Blackberry, etc.), and device types (e.g., mobile smart phones, tablets, laptops, desktops, etc.). Using the techniques described herein, only intended accounts on intended devices are able to decrypt the communications. Thus, for example, the security platform 120 and the server 100 are unable to decrypt communications between the first client device 116 and the second client device 118. As will further be described in more detail below, using the techniques described herein, communicants can maintain forward and backward secrecy over a secure communication channel.

In preferred embodiments, security platform 120 may be implemented on server 100. Server 100 may be a stand-alone server, a corporate server, or a server located in a server farm or cloud-computing environment. Alternatively, server 100 may be a cloud service provider running a virtual machine configured to provide security platform 120 to an enterprise in the context of Software as a Service (SaaS). Accordingly, server 100 includes a processor 102, memory 104, user directory 106, and the security platform 120. Processor 102 may be any processor capable of executing instructions and interacting with memory 104, user directory 106, and security platform 120. In this regard, processor 102 may include a processor, multiprocessors, a multicore processor, or any combination thereof. Alternatively, processor 102 may be a dedicated controller, such as an Application Specific Integrated Circuit (ASIC) or Field Programmable Gate Array (FPGA). As will be described in more detail below, processor 102 may perform a plurality of tasks on behalf of security platform 120. Furthermore, whenever platform 120 is described as performing a task, either a single component or a subset of components or all components of platform 120 or server 100 may cooperate to perform the task.

Memory 104 stores information accessible by processor 102, including instructions and data that may be executed or otherwise used by the processor 102. For example, security platform 120 may be stored in memory 104. In this regard, memory 104 may be any type of media capable of storing information accessible by the processor, including a non-transitory computer-readable medium or any other suitable medium that stores data that may be read with the aid of an electronic device, such as a hard-drive, solid state drive, memory card, flash drive, ROM, RAM, DVD, or other optical disks, as well as other write-capable and read-only memories. Memory 104 may include short term or temporary storage as well as long term or persistent storage. According to some embodiments, memory 104 may include a storage area network (SAN) accessible by the security platform 120.

User directory 106 may be any database or table capable of providing directory services. For example, user directory may include a corporate directory that includes employees' first and last names, usernames, email address, phone numbers, department information, etc. Alternatively, user directory 106 may be a database or table to maintain user information for users of security platform 120. In this regard, user directory 106 may be encrypted. In some embodiments, user directory 106 may serve as a secure directory, in lieu of or in conjunction with database 130, that includes a table of hashed usernames, a table of application identifiers (appIDs), and a table of device identifiers (deviceIDs). Accordingly, user directory 106 may be used to share information about users, systems, networks, services, and applications. According to some embodiments, the user directory 106 may include a Lightweight Directory Access Protocol (LDAP) or a comparable form of active directory.

Security platform 120 may be configured to facilitate the exchange of communications and information for users of a secure collaboration app, such as first app 146 on first client device 116 and second app 148 on second client device 118. As used herein, “communications” and “messages” may take a variety of forms, including: text messages, chat room messages, file sharing, file collaboration, application sharing, control messages, commands, e-mails, documents, audiovisual files, Short Message Service messages (SMSes), and telecommunications. Telecommunications, as used herein, refers to audio calls, voice calls (e.g. PBX, VOIP), audiovisual conferences, audio conferences, video calls, videoconferences, and other forms of multimodal communications. Additionally, the content of the messages and/or communications may pertain to electronic transactions, such as credit card security, password protection, directories, and storage drive protection, video on demand security, online gaming, gambling, electronic distribution of music, videos, documents, online learning systems, databases, cloud storage and cloud environments, bank transactions, voting processes, military communications, security of medical records, communication between medically implanted devices and doctors, etc. The exchange of messages and/or communications is explained in further detail below.

In order to facilitate encrypted communications, security platform 120 includes database 130 that stores information in a variety of tables. In particular, database 130 may include a record for each user of platform 120 to allow users to find other users and exchange communications and information with other users of the security platform. Accordingly, database 130 may include a table of hashed usernames 132, a table of public keys and reference values 134, a table of application identifiers 136, and a table of device identifiers 138. Each user record may include a hashed username in table 132, a pool of ephemeral Elliptic Curve Diffie-Hellman (ECDH) public components and associated reference values in table 134, application identifiers in table 136, and device identifiers in table 138. Additionally, each user record may store privacy mode and privacy list entries to control with whom the user may communicate. Additionally, database 130 may include a table of communications 140. That is, the security platform 120 may store communications and notifications for users for a predetermined time in table 140. For example, when a message is received, the security platform may store the message in the table of communications and provide an alert, such as a push notification, to the one or more receivers. Accordingly, a receiver may access the security platform to obtain his or her communications stored in table 140. In preferred embodiments, table 140 may store communications for 30 days; however, this may be adjusted, as needed, based on industry standards and/or to comply with industry-mandated regulations. In alternative embodiments, the table of communications 140 may store control messages and/or notifications for shared files or secure telecommunications. Receivers' secure collaboration apps may access these control messages and/or notifications to obtain the information for obtaining the shared files or joining the secure telecommunication.

Security platform 120 may include one or more interface(s) 122 for communicating with client devices 116 and 118, as well as access control server 150, DLP server 160, and document management system 170. As one example, platform 120 may provide an application programming interface (API) configured to communicate with the secure collaboration apps 146 and 148 installed on client devices 116 and 118, respectively. Further, security platform 120 may also include APIs for interacting with the access control server 150, DLP server 160, and document management system 170. Additionally, security platform 120 may provide other types of interfaces, such as a web interface, or stand-alone software programs for desktops and laptops, running on various Operating Systems (OSes). The web interface may allow users of client devices to exchange communications securely (whether with one another or other users), without the need for a separately installed collaboration application, thereby allowing users to exchange secure communications via a web interface. According to alternative embodiments, security platform 120 may use the native interfaces available from server 100 to communicate with the first secure collaboration app 146 and the second secure collaboration app 148, as well as access control server 150, DLP server 160, and document management system 170. According to some examples, server platform 120 may make a master clock time available via the one or more interface(s) 122. The master clock time may be used by the secure collaboration apps 146 and 148 to enforce secure time-to-live (TTL) values of communications. The TTL values can be used to enforce (e.g., on behalf of a sender) time constraints on communication access (e.g., by a receiver).

As discussed above, security platform 120 facilitates the exchange of communications, control messages, and information via network 112. In this regard, network 112 may include various configurations and use various protocols including the Internet, World Wide Web, intranets, virtual private networks, local Ethernet networks, private networks using communication protocols proprietary to one or more companies, cellular (e.g., 3G, LTE, etc.) and wireless networks (e.g., WiFi), instant messaging, HTTP and SMTP, and various combinations of the foregoing. According to some embodiments, network 112 is an internal corporate network, a distributed corporate network, the internet, or a combination thereof. For example, first client device 116 may exchange communicates with second client device 118 through some combination of a cellular network, the internet, and an internal corporate network.

The security platform 120 permits users of the first client device 116 and the second client device 118 to communicate securely with one another via a secure collaboration app. Client devices may include mobile devices, such as a laptop, smart phone, or tablet, or computing devices, such as desktop computers or servers. As noted above, the secure collaboration app described herein allows cross-platform communications, thereby allowing users of various devices to communicate seamlessly, thereby improving the collaboration capabilities of a corporate network. Further, each user may have different instances of the collaboration app across multiple devices. That is, the user of the first client device 116 may be able to receive communications on any additional devices (not shown) that have a copy of the secure collaboration app. For example, the first client device 116 may be a mobile device on which a first user sends and receives secure communications via the secure collaboration app. The first user may also have a version of the secure collaboration app installed on his/her laptop, which would also obtain a copy of secure communications that the first user sends from and receives on the first client device. In some embodiments, the first and second client devices 116, 118 may be personal devices (i.e. a bring your own device (BYOD) scenario). Alternatively, client devices may include other types of devices, such as game consoles, camera/video recorders, video players (e.g., incorporating DVD, Blu-ray, Red Laser, Optical, and/or streaming technologies), smart TVs, and other network-connected appliances, as applicable. According to one embodiment, client devices 116, 118 may be landline phones and the security platform and communication server may be installed on a Private Branch Exchange (PBX) or other corporate phone network.

Security platform 120 provides an encrypted communication solution to corporate entities that easily integrates into and secures existing systems while also ensuring that corporate entities maintain compliance with state and federal regulations. In this regard, security platform 120 may integrate with existing identity systems and include built-in support for communicating with access control server 150, DLP system 160, and document management system 170. Accordingly, the security platform 120 may communicate with the access control server 150, DLP system 160, and document management 170 via network 114, which may be similar to network 112 discussed above.

Access control server 150 may be configured to manage user roles and access to enterprise data, information, resources, and systems. Accordingly, access control server may be a stand-alone server, a corporate server, a cloud service provider running a virtual machine, or a server located in a server farm or cloud-computing environment. According to some embodiments, access control server 150 may be co-located on the same server, or cluster of servers, as security platform 120, DLP system 160, or document management system 170. In this regard, access control server 150 includes at least one processor (not shown), memory (not shown), and one or more access control lists 152. Access control lists 152 define which users and systems may access data and the operations that they are permitted to perform on accessible data. In operation, access control server 150 may interface with security platform 120, as well as the first collaboration app 146 and the second collaboration app 148, to ensure that users access data, and perform operations on that data, in accordance with their role as defined in access control list 152. For example, if the first user of the first collaboration app 146 decides to share a first file with a second user of the second collaboration app 148, the first collaboration app 146 determines whether the first user has permission to share the first file with the second user by sending a request to the access control server 150. The access control server 150 responds to the request from the first collaboration app 146 indicating whether the first user has permission to share the file and whether the user of the second collaboration app 148 has permission to receive and access the first file.

DLP system 160 is capable of detecting potential data leaks by monitoring, detecting, and blocking the transmission of sensitive data. Similar to access control server 150, DLP system 160 may be a stand-alone server, a corporate server, a cloud service provider running a virtual machine, or a server located in a server farm or cloud-computing environment. According to some embodiments, DLP system 160 is co-located with security platform 120, access control server 150, and/or document management system 170. DLP system 160 may collaborate with the first collaboration app 146 and the second collaboration app 148, via the security platform 120, to verify that users are not ex-filtrating sensitive information. In order to verify that the first user of the first collaboration app 146 is not ex-filtrating data, the first collaboration app 146 allows the DLP system 160, via an interface—such as an API, to review the content of communications prior to being encrypted and transmitted to one or more receivers. In this regard, reviewing the content of communications before they are encrypted and transmitted is an improvement over prior art systems, which merely flag communications for an administrator's review after they have already been transmitted;

The document management system 170 may be configured to track the transfer and sharing of files in accordance with users' roles. In this regard, the document management system 170 may work in conjunction with the access control server 150. Document management system 170 may be a stand-alone server, a corporate server, a cloud service provider running a virtual machine, or a server located in a server farm or cloud-computing environment. According to some embodiments, DLP system 160 is executed on the same server as security platform 120, access control server 150, and/or DLP system 160. In operation, document management system 170 classifies files based on their certain information, such as the author, department of origination, content of the document, etc., and defines the privileges necessary to access a file. According to some embodiments, the document management system 170 may distribute an authorization key to be used to encrypt communications in accordance with the file's permission level. As previously discussed, the document management system may classify files based on their content. Accordingly, each classification level may be associated with a different authorization key. For instance, a first authorization key would be assigned to classified files, a second authorization key would be assigned to internal use only files, a third authorization key would be assigned to non-public information, etc. According to other examples, authorization keys may be assigned to files based on roles, like those defined in access control list 152. In still other examples, the document management system may generate ephemeral asymmetric key pairs for each classification level. The public key would be distributed to senders and be used, in conjunction with a sender's ephemeral private key, to derive a key-encrypting key to encrypt the communication key. Accordingly, the corresponding private key would be distributed to the one or more receivers.

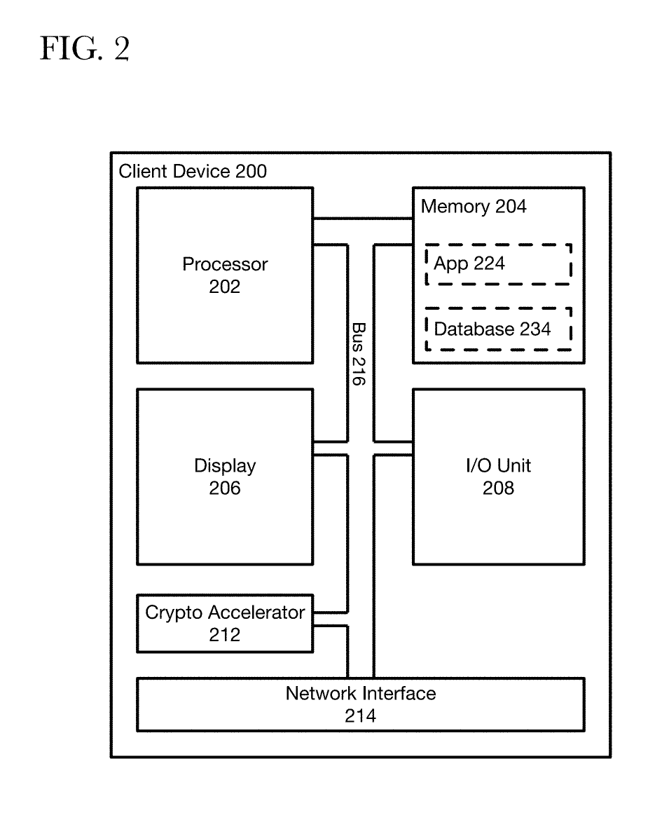

In order to exchange information via the secure collaboration apps 146 and 158, users must install the app on their device. FIG. 2 illustrates an exemplary client device 200 that may access the security platform 120 via a secure collaboration app. In this regard, client device 200 includes a processor 202, a memory 204, a display 206, an I/O unit 208, a cryptographic (“crypto”) accelerator 212, and a network interface 214 all interconnected by bus 216.

Processor 202 may be any processor capable of interacting with the components of client device 200. For example, processor 202 may include a processor, multiprocessors, multicore processor, a dedicated controller, such as an ARM processor, an ASIC, or an FPGA, or any combination thereof. Memory 204 may store information accessible by processor 202, including instructions and data that may be executed or otherwise used by the processor 202 and/or crypto accelerator 212. For example, memory 204 may store instructions, such as app 224. In preferred embodiments, app 224 may be a secure collaboration app that provides users with the ability to participate in voice and video calls, share encrypted content, and exchange encrypted communications. Encrypted communications may include direct communications (e.g., one-to-one communications between a sender and receiver), group chats, or secure chat room communications. Data stored by memory 204 may include database 234. Database 234 may be encrypted via an encryption algorithm, such as Advanced Encryption Standard (AES), and a 256-bit key, referred to hereinafter as a local storage key. In some embodiments, database 234 may store information related to secure collaboration app 224. For example, database 234 may index information related to the secure collaboration app, such as key information, user information, friend information, and communications. In this regard, communications transmitted and received by the secure collaboration app, including a message identifier, a hash of the sender's username, a hash of the sender's application identifier, a hash of the receiver's username, a hash of the receiver's application identifier, the communication encryption key, and a timestamp of each communication may be stored in database 234. Accordingly, memory 204 may be any type of media capable of storing the information above, including a non-transitory computer-readable medium or any other suitable medium that stores data that may be read with the aid of an electronic device, such as a hard-drive, solid state drive, memory card, flash drive, ROM, RAM, DVD, or other optical disks, as well as other write-capable and read-only memories. Further, memory 204 may include short term or temporary storage as well as long term or persistent storage.

Display 206 may be any electronic device capable of visually presenting information. In mobile devices, such as smart phones and tablets, display 206 may be a touchscreen display. Accordingly, display 206 may be integrated with I/O unit 208 to detect user inputs, as well as output data. In computing devices, display 206 may be an output, such as a VGA, DVI, or HDMI output, configured to connect to a monitor. I/O unit 208 may be capable of receiving input from a user. As noted above, the I/O unit 208 may work with touchscreen displays to receive input from a user. Alternatively, the I/O unit may be an interface capable of interacting with input and output devices, such as keyboards, mice, monitors, printers, etc. Additionally, the I/O unit 208 may include at least one accelerometer, a Global Positioning Satellite (GPS) system, a magnetometer, a proximity sensor, an ambient light sensory, a moisture sensor, a gyroscope, etc. to determine the orientation of the device, as well as environmental factors.

Crypto accelerator 212 may be dedicated hardware, software, or any combination thereof that is capable of performing cryptographic operations, such as key generation, random number generation, encryption/decryption, signature generation, signature verification, etc. In preferred embodiments, crypto accelerator 212 is a dedicated processor configured to perform cryptographic operations on behalf of processor 202. In this regard, app 224 may make use of crypto accelerator 212 to provide the secure communication functions described in greater detail below.

Network interface 214 may be dedicated hardware, software, or any combination thereof that is capable of connecting client device 200 to network 112. In this regard, network interface 214 may include various configurations and use various communication protocols including Ethernet, TCP/IP, ATM, cellular and wireless communication protocols (e.g. 802.11, LTE), instant messaging, HTTP and SMTP, and various combinations of the foregoing.

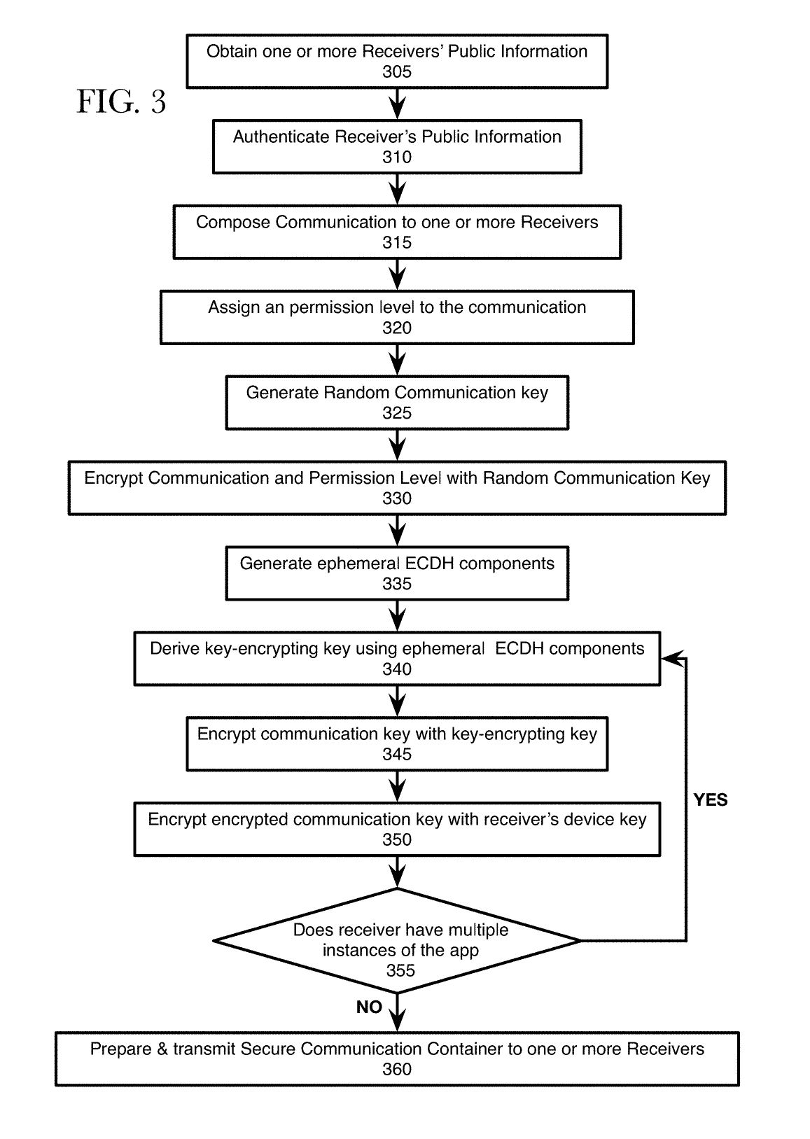

In order to send and receive secure communications, both the sender and receiver need to have a copy of the secure collaboration app running on their respective devices to share encrypted communications. In this regard, FIG. 3 illustrates an exemplary process for transmitting encrypted communications that effectively binds the communication to a permission level and the receiver's secure collaboration application and device. The method begins in bock 305, with the sender's app obtaining one or more receivers' public information. Obtaining the one or more receivers' public information may include transmitting a request to the security platform, or another secure directory, for the one or more receivers' public information. In response to receiving the request, the security platform or secure directory responds with the one or more receivers' public information. In this regard, the public information may include at least one of the receiver's application identifier, user-level signing public key, signed app-level signing public key, a signed ephemeral ECDH public component, an identifier of the ephemeral ECDH public component, and the receiver's device key. In some embodiments, the receiver's public information may also include information regarding the receiver's role within the organization. The role information may include the receiver's permission level, which department they work for, and permission information detailing the information that the receiver may access and the operations that he or she can perform on that information. In preferred embodiments, the security platform may randomly select one of the signed ephemeral ECDH public components from a pool of public components that the receiver has previously uploaded to security platform 120. Further, the security platform will delete the selected ephemeral ECDH public component so it is not used for any subsequent communications. If the receiver has multiple instances of the secure collaboration app installed on different devices, the sender's app will receive a unique signed app-level signing public key, signed ephemeral ECDH public component, identifier of the ephemeral ECDH public component, and device key for each instance of the secure collaboration app in block 305. The multiple instance information may be provided in an arrayed response by the security platform.

In block 310, the sender's app authenticates the public information received from the security platform. In this regard, the user-level signing public key received from security platform is used to verify a signature attached to the app-level signing public key. If the receiver has multiple instances of the app, the sender's app will authenticate the app-level public key for each of the receiver's apps. When the signature attached to the app-level public key is successfully validated, the sender's app uses the app-level signing public key to validate the signatures appended to the received ephemeral ECDH public component. Validating the app-level signing public key and the received ephemeral ECDH public component may be repeated for each instance of the receiver's secure collaboration app.

After authenticating the receiver's public information, the sender begins composing their communication to the one or more receivers in block 315. In block 320, the sender's secure collaboration app may assign a permission level to the communication. This may include setting a flag in the communication indicating the permission level to the one or more receivers' secure collaboration apps. The permission level may be assigned to the communication by a third party via an application programming interface of the sender's secure collaboration app. In this regard, the third party may be the access control server, the DLP system, and/or the document management system. For instance, the DLP system may assign a permission level to the communication after reviewing the content of the communication. Alternatively, the document management system may assign a permission level to the communication based on the permissions associated with a file being shared by the sender. In other examples, the permission level is assigned to the communication by the sender. For example, the sender selects the minimum permission level necessary to view the content of the communication. In this regard, a selection field, such as a drop down menu, may be provided such that the sender may select a classification level (e.g., Top Secret, Secret, Confidential, Restricted, Internal Use Only, etc.) for the content of the communication. For instance, a sender may specify that the communication may only be viewed by people who have permission to access secret files. Thus, in a secure chat room, only those participants who have access to secret files (or higher) will have be able to decrypt and access the shared file. In yet another example, the sender may specify that only certain departments may access the communication. For example, the sender may designate that the communication is intended for the legal department. In this regard, the secure collaboration apps for users that are not in the legal department discard the communication.

While the sender is composing the communication and assigning a permission level to the communication, the sender's app generates a random, 256-bit communication key in block 325. According to some embodiments, the sender's app may use the crypto accelerator described above to generate the communication key. In preferred embodiments, the communication key is a symmetric key generated by passing a set of pseudorandom bytes derived from the sender's device through a key derivation function. The pseudorandom bytes may be obtained from appropriate sources, such as ephemeral environmental noise obtained from device drivers and other kernel operations. Once the communication is composed and the communication key generated, the sender's app will encrypt the communication and the assigned permission level in block 330. The secure collaboration app may encrypt the communication and the assigned permission level, via the crypto accelerator, using a symmetric encryption algorithm. In some embodiments, the secure collaboration app encrypts the communication and the permission level using the Advanced Encryption Standard (AES).

In block 335, the sender's app generates a pair of ephemeral ECDH components. The pair of ephemeral ECDH components is generated using ECC. In block 340, the sender's app derives a key-encrypting key using the receiver's ephemeral ECDH public component and the ephemeral ECDH private component generated by the sender's app. In preferred embodiments, the key-encrypting key is a 256-bit key derived according to ECDH.

In block 345, the communication key is encrypted a first time in accordance with the key-encrypting key. In preferred embodiments, the communication key is encrypted by the crypto accelerator using AES and the key-encrypting key. Next, in block 350, the sender's secure collaboration app encrypts the encrypted communication key a second time according to the receiver's device key obtained from the security platform with the receiver's public information. Preferably, the encrypted communication key is encrypted by the crypto accelerator. This approach provides a twice-encrypted communication key that effectively binds the communication to the receiver's secure collaboration app and device.

In block 355, the sender's secure collaboration app determines whether the receiver has multiple instances of the secure collaboration app installed on a plurality of devices. If so, the sender's app repeats the steps of blocks 340, 345, and 350 for each instance of the receiver's secure collaboration app. In this regard, each instance will receive a twice-encrypted communication key that is unique to that instantiation of the secure collaboration app. Accordingly, each instance will only be able to decrypt the twice-encrypted communication key that has been encrypted with the unique device key and ephemeral public component associated with the secure collaboration app on the receiver's device.

When twice-encrypted communication keys have been generated for each of the receiver's instantiations of the secure collaboration app, the sender's app prepares and transmits a secure communication container in block 360. In preparing the secure communication container for transmission, the sender's secure collaboration app encapsulates the encrypted communication, the encrypted permission level, the twice-encrypted communication key, and the sender's ephemeral ECDH public component. In this regard, the secure communication container includes a payload and a header. The payload comprises the encrypted communication and the encrypted permission level. The header includes destination entries for each of receiver's apps. That is, the sender's app addresses the communication in a one-to-many manner. For instance, the sender addresses the communication to the receiver, but the sender's app composes a secure communication container that is addressed to each of the receiver's secure collaboration apps. Accordingly, each destination entry includes the twice-encrypted communication key specific to the instance of the receiver's app; the ephemeral ECDH key identifier unique to the receiver's app; and the sender's signed ephemeral public component. Once the secure communication container is assembled, the sender's secure collaboration app transmits the secure communication container to the receiver. In preferred embodiments, the sender's app transmits a single secure communication container to the security platform. Accordingly, the security platform will notify receivers that they have new messages waiting for them, and the single secure communication container will be distributed to the one or more receivers from the security platform. Alternatively, the sender and receiver may communicate via a peer-to-peer protocol. According to these embodiments, the sender's app may transmit the secure communication container directly to the receiver.

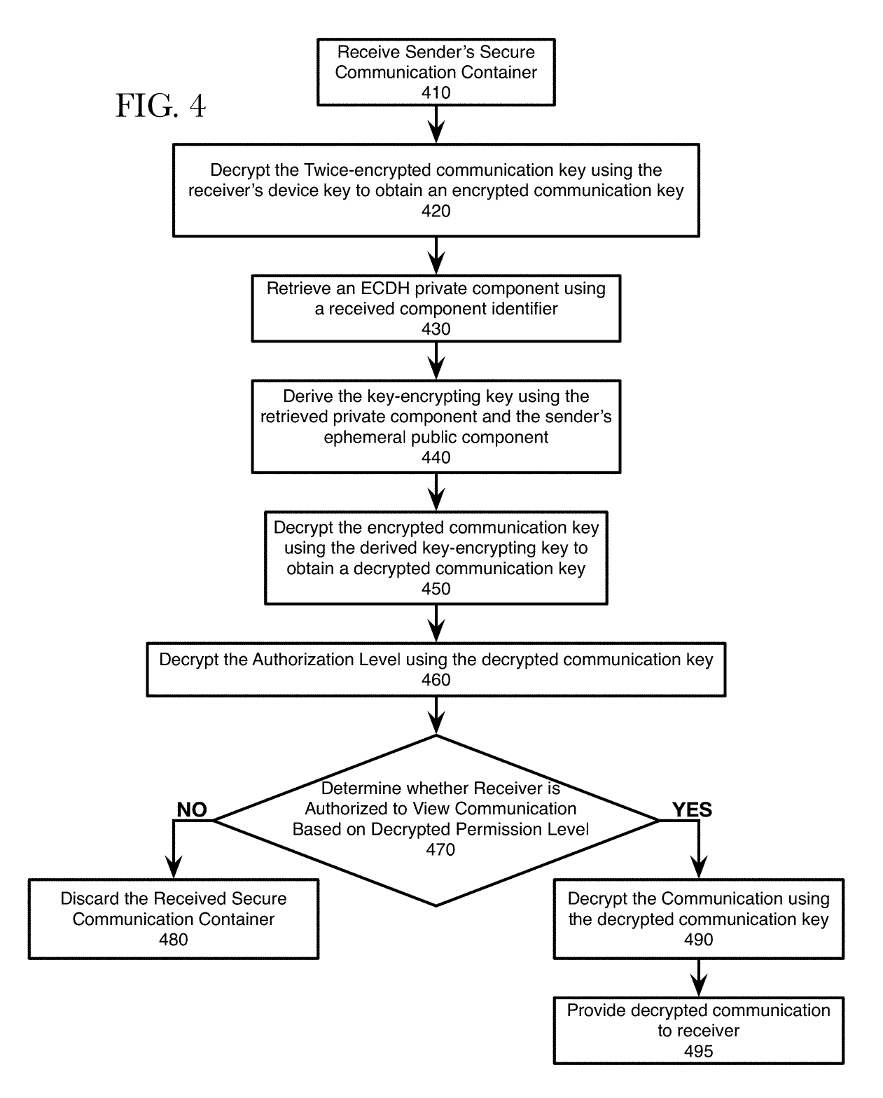

Upon receipt of the secure communication container, receivers' secure collaboration apps decrypt the encrypted communication and determine whether the receiver is authorized to access the content of the communication. FIG. 4 illustrates an exemplary process for receiving and decrypting a secure communication container received from a sender according to a first embodiment of the disclosure. In block 410, the receiver's secure collaboration app receives the sender's secure communication container. As noted above, retrieving the sender's secure communication container may be in response to receiving an alert, such as a push notification, from the security platform. The receiver's secure collaboration app may connect to the security platform and download the sender's secure communication container. Alternatively, the receiver's secure collaboration app may receive the sender's secure communication container directly from the sender's device via a peer-to-peer protocol.

In block 420, the receiver's secure collaboration app decrypts the twice-encrypted communication key using the device key associated with the receiver's device. Next, in block 430, the receiver's secure collaboration app uses the ECDH component identifier received in the secure communication container to retrieve the ephemeral ECDH private component that corresponds to the public component used to generate the key-encrypting key. In block 440, the receiver's secure collaboration app derives the key-encrypting key using the retrieved ephemeral private component and the sender's ephemeral public component received in the secure communication container. After deriving the key-encrypting key, the receiver's secure collaboration app decrypts the encrypted communication key in block 450 to obtain a decrypted communication key. In block 460, the decrypted communication key is used to decrypt the encrypted permission level. In preferred embodiments, the permission level is decrypted via a symmetric encryption/decryption scheme, such as AES. In block 470, the receiver's secure collaboration app determines whether the receiver is authorized to view the content of the encrypted communication based on the decrypted permission level. For example, the receiver's secure collaboration app may compare the received permission level (e.g. the flag set in the secure communication container) with an access role defined on the receiver's device. The access role may be provided to the receiver's device from the access control server when the user logs into a corporate network. In other examples, the receiver's secure collaboration app may send a request, that includes the decrypted permission level, to the access control server. The access control server provides a response indicating whether the receiver has permissions to decrypt the encrypted communication.

If the receiver does not have permission to view the encrypted message, the receiver's secure collaboration app discards the received secure communication container in block 480. In this way, the receiver will not be able to access the content of the encrypted message. However, if receiver's secure collaboration app determines that the receiver has permission to view the communication, the process proceeds to block 490 where the receiver's secure collaboration app decrypts the communication using the decrypted communication key. As noted above, the communication is decrypted according to a symmetric encryption algorithm, such as AES. Finally, the decrypted communication is provided to the receiver in block 495. In order to protect the data at rest on the receiver's device, the decrypted communication may be encrypted locally on the receiver's device using the local storage key. As noted above, the local storage key is a 256-bit key, or higher, that is derived from the receiver's password and used to encrypt data on the receiver's device via a symmetric encryption algorithm. Thus, the secure collaboration app secures data, both in-transit and at-rest.

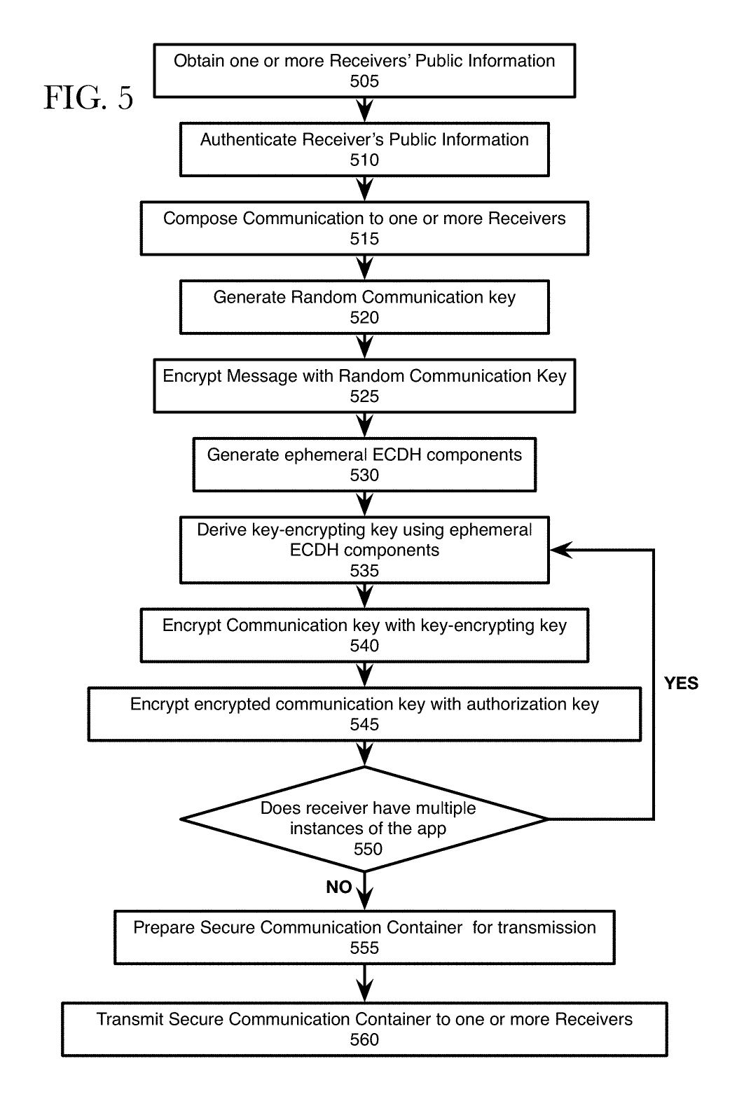

In an alternative embodiment, the secure communication platform replaces the device key with an authorization key to effectively bind the communication to a permission level and a receiver's secure collaboration app. FIG. 5 illustrates a process for transmitting encrypted communications according to a second embodiment. As with the process described in FIG. 3 above, the sender's secure collaboration app begins composing a communication to one or more receivers in block 505 by obtaining the one or more receivers' public information from a secure directory. In some examples, the request for one or more receivers' public information may include a permission level assigned to the communication by the sender. In block 510, the sender's app receives public information received from the security platform and authenticates it. In addition to the public information described above, an authorization key is provided to the sender's secure collaboration app according to this embodiment. In some examples, the authorization key may be provided to the security platform from the access control server in accordance with the permission level assigned by the sender. Alternatively, the authorization key may be provided to the sender by the DLP system, via the security platform. For example, the DLP system may review the content of the sender's communication, via an API located in the sender's secure collaboration app, and assign a permission level based on the content of the communication. Accordingly, the DLP system may provide the authorization key to the secure platform based on the content of the communication, the permission level assigned to the communication, or a combination thereof. The secure platform, in turn, provides the sender with the authorization key. In examples where the communication is a secure file transfer, the document management system, via the security platform, may provide the sender with the authorization key. According to these examples, the authorization key may be based on the permissions associated with the file. Alternatively, the authorization key could be a unique key used to encrypt the file, thereby allowing an author of the file to control whom may access the file.

Once the one or more receivers' public information is authenticated, the sender composes their communication to the one or more receivers in block 515. Authenticating the one or more receivers' public information may occur while the sender composes the communication. Alternatively, the one or more receivers' public information may be authenticated while the sender modifies one or more parameters, such as a time-to-live, of the communication. In block 520, the sender's secure collaboration app derives a random, 256-bit communication key using one of the previously discussed techniques. Once the communication is composed and the communication key generated, the sender's secure collaboration app encrypts the communication using the derived random communication key in block 525. In block 530, the sender's secure collaboration app generates a pair of ephemeral ECDH components according to ECC. In block 535, the sender's secure collaboration app derives a key-encrypting key using the receiver's ephemeral ECDH public component and the ephemeral ECDH private component generated by the sender's app. In block 540, the communication key is encrypted a first time using the key-encrypting key derived by the sender's secure collaboration app. Next, in block 545, the sender's secure collaboration app encrypts the encrypted communication key a second time using the authorization key discussed above. In block 550, the sender's secure collaboration app determines whether the receiver has multiple instances of the secure collaboration app installed on a plurality of devices. If so, the sender's secure collaboration app repeats the steps of blocks 535, 540, and 545 for each instance of the one or more receiver's secure collaboration app. When twice-encrypted communication keys have been generated for each of the one or more receiver's instantiations of the secure collaboration app, the sender's secure collaboration app prepares a secure communication container in block 555. As noted above, the sender's secure collaboration app prepares a single secure communication container that includes information for the one or more receivers. Upon receipt of the secure communication container, the security platform will notify each of the one or more receivers of the secure communication container. In this regard, a single communication is transmitted from the sender's secure collaboration app and is distributed to the one or more receiver's by the security platform.

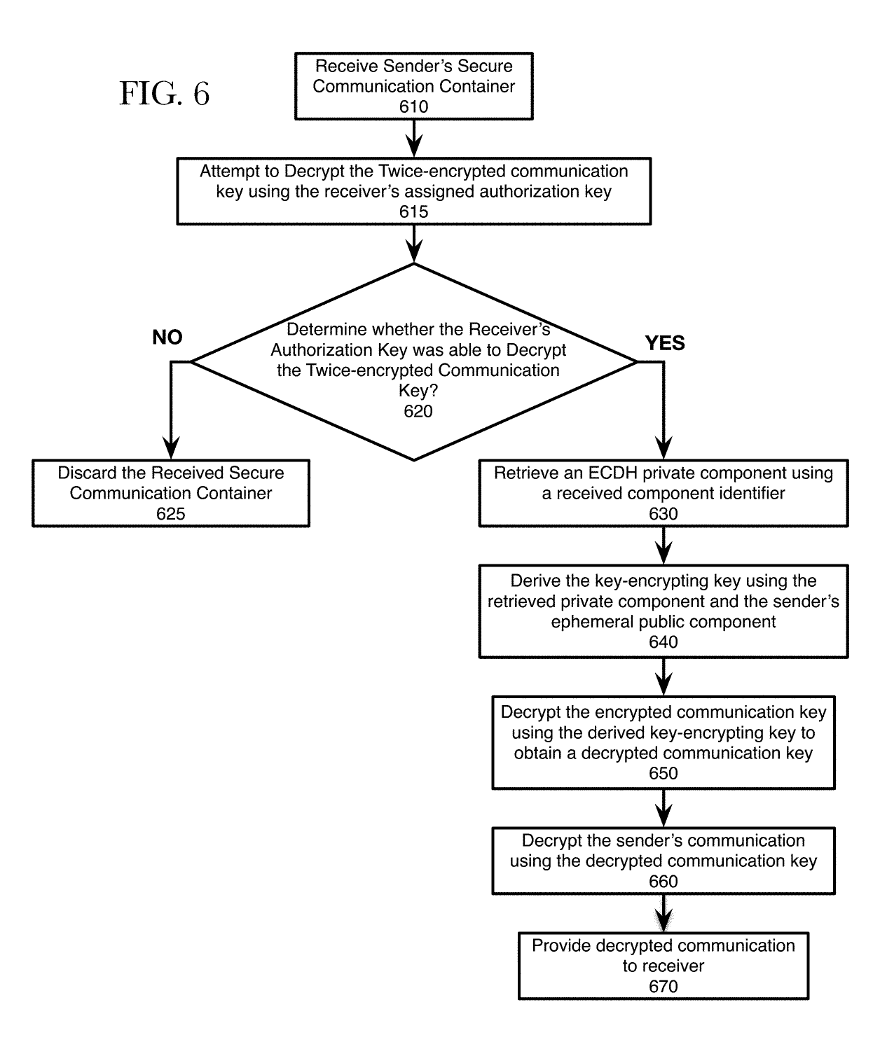

Upon receipt of the secure communication container, the one or more receivers' secure collaboration apps attempt to decrypt the encrypted communication and provide the decrypted communication to the one or more receivers. FIG. 6 illustrates an exemplary process for receiving and decrypting a secure communication container according to a second embodiment of the disclosure. In block 610, the one or more receivers' secure collaboration app receives the sender's secure communication container. In block 615, the one or more receivers' secure collaboration app attempts to decrypt the twice-encrypted communication key using the one or more receivers' authorization key(s). As noted above, the authorization key may be provided to the one or more receivers based on their role within an organization. For example, the authorization key may be associated with the classification level the one or more receivers is authorized to view. Alternatively, the authorization key may be provided in accordance with the department the one or more receivers belongs to. In block 620, the one or more receivers' secure collaboration apps determines whether the authorization key was able to decrypt the twice encrypted communication key. In this regard, the receiver's secure collaboration app may attempt to decrypt the twice-encrypted communication key a predetermined number of times before determining that it is unable to decrypt the twice-encrypted communication key. When the receiver's secure collaboration apps determines that it was unable to decrypt the twice-encrypted communication key with the receiver's authorization key, the process proceeds to block 625 where the received secure communication container is discarded.

However, if the one or more receivers' secure collaboration apps is able to decrypt the twice-encrypted communication key with their authorization key, the process proceeds to block 630, where the receiver's secure collaboration app retrieves the ephemeral ECDH private component using the ECDH component identifier received in the secure communication container. In block 640, the receiver's secure collaboration app derives the key-encrypting key using the retrieved ephemeral private component and the sender's ephemeral public component received in the secure communication container. After deriving the key-encrypting key, the receiver's secure collaboration app decrypts the encrypted communication key in block 650 to obtain a decrypted communication key. In block 660, the decrypted communication key is used to decrypt the communication using the decrypted communication key. Finally, the decrypted communication is provided to the receiver in block 670.

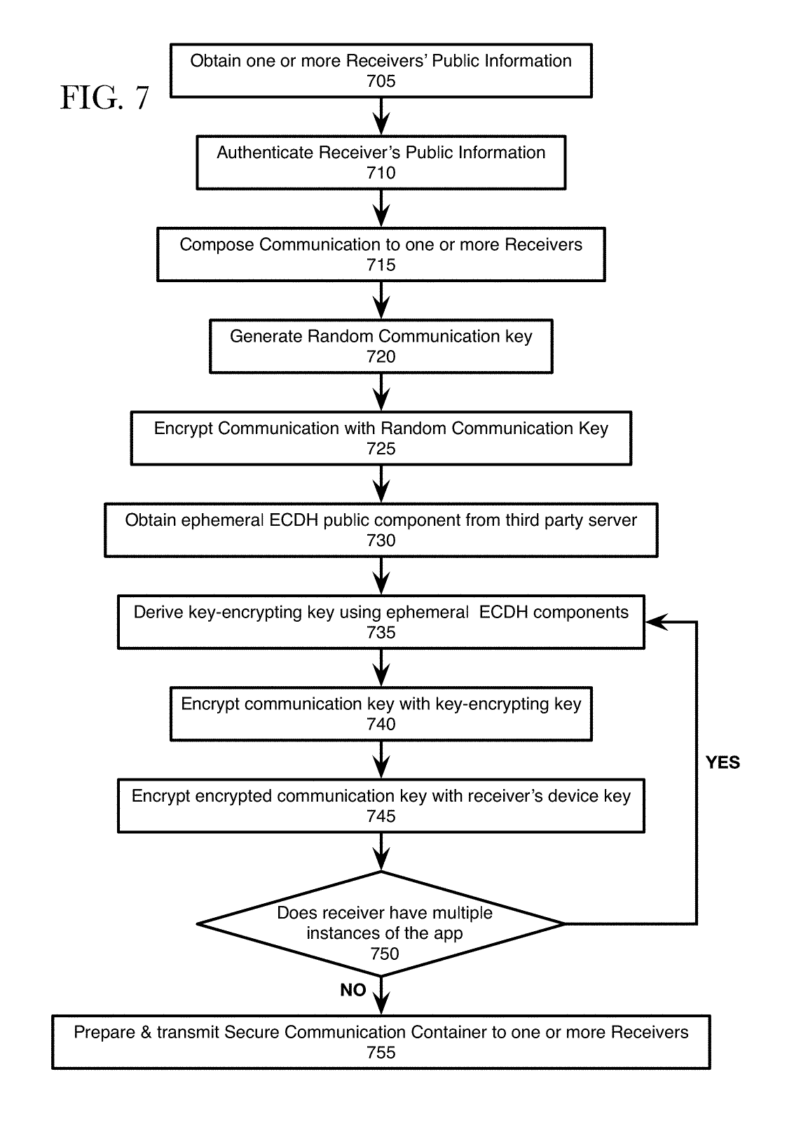

In yet another embodiment, the secure communication platform may provide a sender with the ability to specify which device a receiver who has multiple devices may view the sender's communications. Accordingly, the device key described above would be essential since the device key is necessarily tied to each receiver's device. Therefore, in order to provide the sender with the ability to specify which device the communication is received on, while still ensuring that the content of the communication is protected, the sender will generate a key-encrypting key that is derived, at least in part, on the permission level associated with the content of the communication. FIG. 7 illustrates a process for transmitting encrypted communications according to this example.

Similar to the transmission techniques described above, the sender's secure collaboration app obtains public information for one or more receiver's public information from a secure directory in block 705. Next, in block 710, the sender's secure collaboration app authenticates the public information received from the security platform. After authenticating the one or more receivers' public information, the sender composes their communication to the one or more receivers in block 715. Authenticating the one or more receivers' public information may occur at the same time the sender composes the communication. In block 720, the sender's secure collaboration app derives a random, 256-bit communication key. Once the communication is composed and the communication key generated, the sender's secure collaboration app encrypts the communication with the derived random, communication key in block 725. In block 730, the sender's secure collaboration app obtains an ephemeral ECDH public components from a third party server, such as the access control server, the DLP system, or the document management system. For example, the sender's secure collaboration app may send a request for the ephemeral ECDH public component to the third party server. In this regard, the third party server may generate an asymmetric key pair for each permission level (e.g., a first asymmetric key pair for Top Secret information, a second asymmetric key pair for Secret information, etc.). In operation, the public component of the asymmetric key pair is distributed to the sender upon their request, while the private component is distributed to the receivers in accordance with their permission level. The asymmetric key pair for each permission level may be updated periodically (e.g., daily, weekly, monthly, etc.). Alternatively, the asymmetric key pair may be updated based on changes to the company. For instance, when an employee is terminated, the asymmetric key pair(s) associated with their permission level may be updated.

After obtaining the ephemeral ECDH public component from the third party server, the sender's secure collaboration app derives a key-encrypting key using the received ephemeral ECDH public component and the ephemeral ECDH private component generated by the sender's secure collaboration app in block 735. By deriving the key-encrypting key according to these inputs, the key-encrypting key the communication is effectively bound to a specific permission level. Next, in block 740, the communication key is encrypted using the derived key-encrypting key. In block 745, the sender's secure collaboration app encrypts the encrypted communication key a second time using the receiver's device key. In block 750, the sender's secure collaboration app determines whether the receiver has multiple instances of the secure collaboration app installed on a plurality of devices. If so, the sender's secure collaboration app repeats the steps of blocks 735, 740, and 745 for each instance of the receiver's secure collaboration app. The twice-encrypted communication key provides an improvement over the prior art by effectively binding the communication to the one or more receivers' device and a permission level.

After the twice-encrypted communication keys have been generated for each of the one or more receiver's instantiations of the secure collaboration app, the sender's secure collaboration app prepares and transmits the secure communication container in block 755. As noted above, the sender's secure collaboration app prepares a single secure communication container that includes information for each of the one or more receivers. Upon receipt of the secure communication container, the security platform will notify each of the one or more receivers of the secure communication container. In this regard, a single communication is transmitted from the sender's secure collaboration app and is distributed to the one or more receiver's by the security platform.

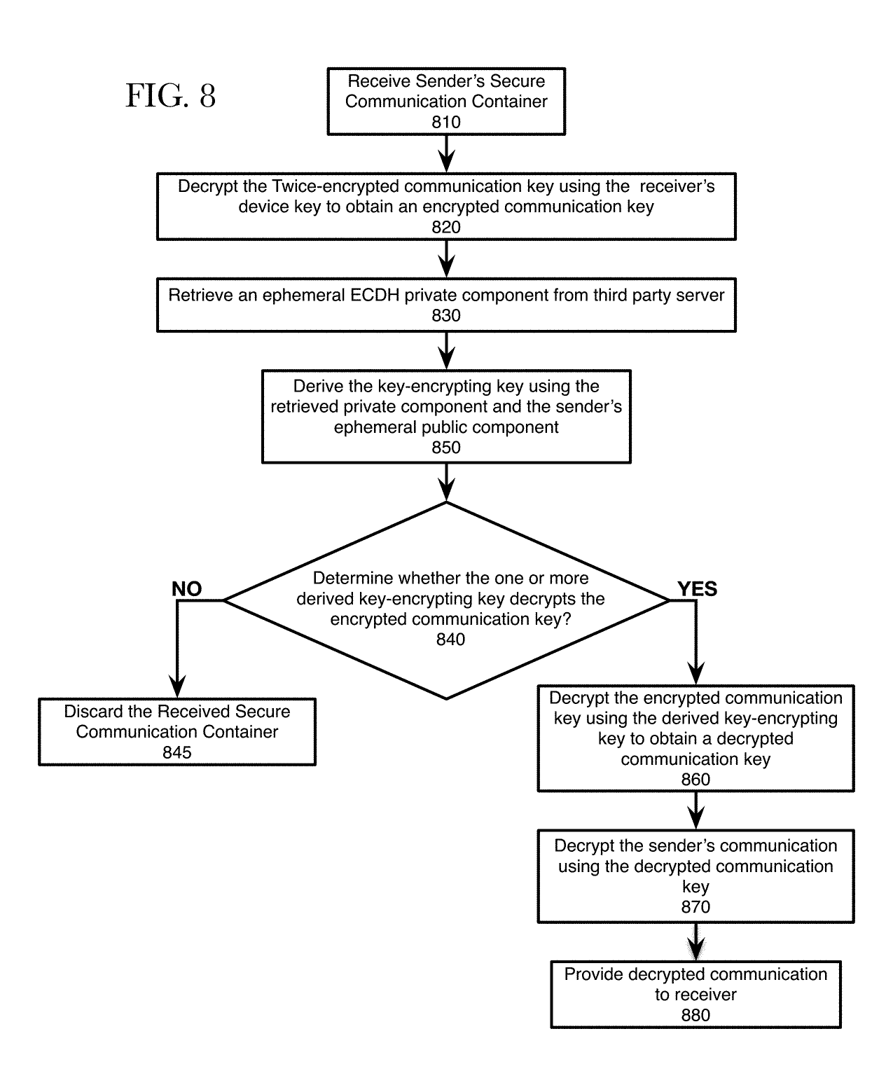

After downloading the secure communication container from the security platform, the one or more receivers' secure collaboration apps attempt to decrypt the encrypted communication and provide the decrypted communication to the one or more receivers. FIG. 8 illustrates an exemplary process for receiving and decrypting a secure communication container according to another example of the disclosure. In block 810, a receiver's secure collaboration app receives the sender's secure communication container. In block 820, the receiver's secure collaboration app decrypts the twice-encrypted communication key using the receiver's device key. In block 830, the receiver's secure collaboration app retrieves the ephemeral ECDH private component. In some examples, the receiver's secure collaboration app retrieves the ephemeral ECDH private component associated with their permission level periodically such that the private component is stored locally on the receiver's device. In other examples, the ephemeral ECDH private component may be pushed to the one or more receivers' secure collaboration apps from a third party server, such as the access control server, the DLP system, or the document management system. In still yet other examples, the one or more receivers' secure collaboration apps may request the ephemeral ECDH private component on-demand. For instance, the receiver's secure collaboration apps may request the ephemeral ECDH private component from a third party server upon receiving the encrypted communication.

In block 840, the receiver's secure collaboration apps determine whether the derived key-encrypting key was able to decrypt the encrypted communication key. If the receiver's secure collaboration app was unable to decrypt the encrypted communication key with the derived key-encrypting key, the process proceeds to block 845 where the received secure communication container is discarded. According to some examples, the received secure communication container may be discarded after a predetermined number of failed attempts to decrypt the encrypted communication key with the derived key-encrypting key.

However, when the receiver's secure collaboration apps is able to decrypt the encrypted communication key with the derived key-encrypting key, the process proceeds to block 860, where the receiver's secure collaboration app decrypts the encrypted communication key to obtain a decrypted communication key. In block 870, the decrypted communication key is used to decrypt the communication. Finally, the decrypted communication is provided to the one or more receivers in block 880.

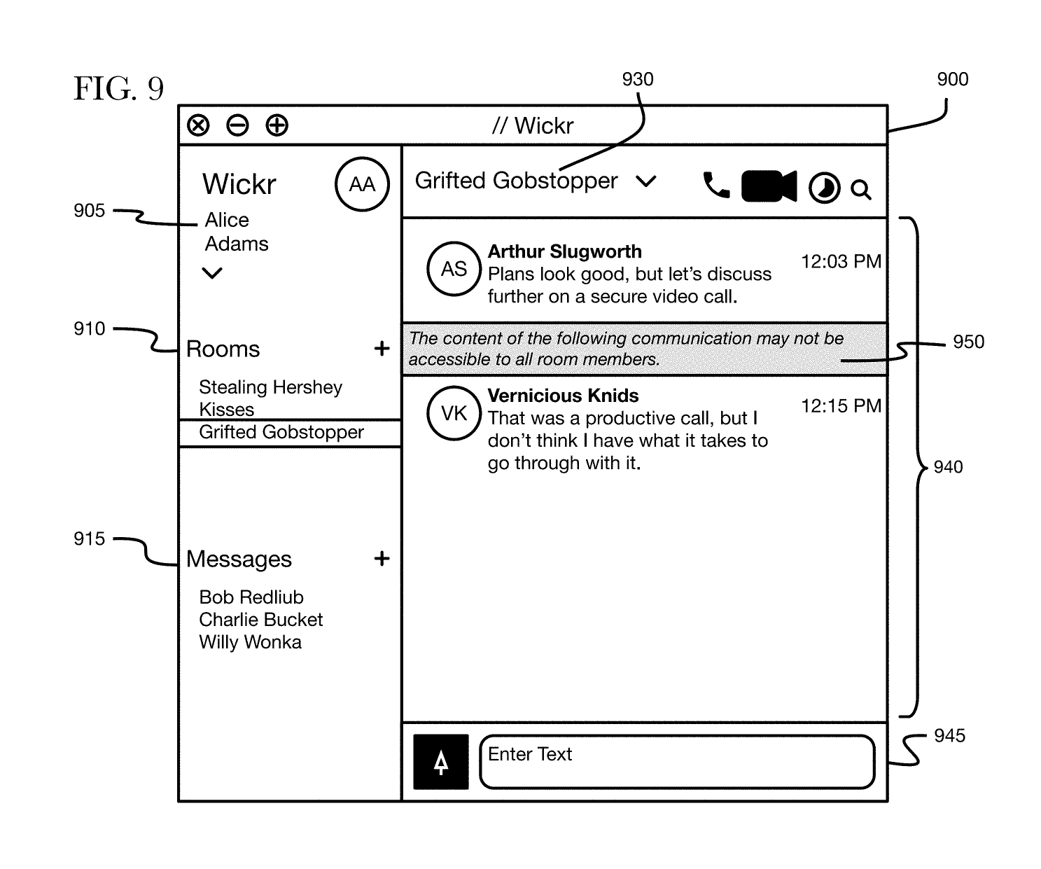

FIG. 9 illustrates an exemplary interface 900 for exchanging cryptographic communications and securely transferring files. The interface 900 includes user information field 905, which displays user information including the user's name, their username, and an avatar that is displayed to other users. As shown in FIG. 9, interface 900 belongs to Alice Adams. Additionally, the interface 900 includes a room identification field 910 and a message identifier field 915. The room identification field 910 and a message identifier field 915 may indicate the secure chat rooms the user is participating in and the open one-to-one communications the user has open, respectively.

FIG. 9 illustrates that Alice Adams is participating in a secure chat room. This is reflected by the highlighted field (e.g. “Grifted Gobstopper”) under the room identification field 910. Additionally, a header 930 shows general information about the communication that the user is participating in. For example, the header 930 may include the name of the secure chat room or one-to-one communication, a TTL for all communications, the members of the secure chat room, and a search field. Below the header, a conversation field 940 is shown. The conversation field 940 may include the communications, including messages, shared images, videos, voice recordings, etc., exchanged between users. Below the conversation field is a user input field 945. The user input field 945 allows a user to enter text and send the text to other communicants. Additionally, the user input field 945 may include an upload button, which allows clients to share content in a secure manner. In operation, the conversation field 940 displays a banner 950 identifying that the following communication constitutes sensitive information and may not be accessible to all members of the secure chat room. While a banner is illustrated in FIG. 9, a different type of notification, such as highlighting or displaying the content in a different color, may displayed to alert the one or more receivers of the communication's limited audience.

Although the foregoing embodiments have been described in some detail for purposes of clarity of understanding, the present disclosure is not limited to the details provided. There are many alternative ways of implementing the present disclosure. The disclosed embodiments are illustrative and not restrictive.

What is claimed is:

1. A method comprising:
composing, at a sending device, a first communication addressed to one or more receivers;
generating, at the sending device, a first communication key;
encrypting, at the sending device, the first communication using the first communication key;
generating, at the sending device, at least one key-encrypting key for each of the at least one receivers, wherein the at least one key-encrypting key is derived according to a key agreement protocol using ephemeral information from the sender and a third party server;
encrypting, at the sending device, the first communication key with the at least one key-encrypting key;
encrypting, at the sending device, the encrypted first communication key with a device key associated with a first receiver to produce a twice-encrypted communication key;
encapsulating, at the sending device, the encrypted first communication and the twice-encrypted first communication key in a secure communication container; and
transmitting, by the sending device, the secure communication container to the one or more receivers.

2. The method of claim 1, wherein the ephemeral information received from the third party server is based on a permission level assigned to the first communication.

3. The method of claim 2, wherein the permission level is assigned to the first communication by the sending device.

4. The method of claim 3, wherein the permission level is assigned to the first communication by the third party server.

5. The method of claim 4, wherein the third party server assigns a permission level based on content of the first communication.

6. The method of claim 1, wherein the third party server is selected from the group consisting of: an access control server, a data loss prevention system, and a document management system.

7. A non-transitory computer-readable medium comprising instructions that when, executed by at least one processor, perform the steps of:
composing a first communication addressed to one or more receivers;
generating a first communication key;
encrypting the first communication using the first communication key;
generating at least one key-encrypting key for each of the at least one receivers, wherein the at least one key-encrypting key is derived according to a key agreement protocol using ephemeral information from the sender and a third party server;
encrypting the first communication key with the at least one key-encrypting key;
encrypting the encrypted first communication key with a device key associated with a first receiver to produce a twice-encrypted communication key;
encapsulating the encrypted first communication and the twice-encrypted first communication key in a secure communication container; and
transmitting the secure communication container to the one or more receivers.

8. The non-transitory computer-readable medium of claim 7, wherein the ephemeral information received from the third party server is based on a permission level assigned to the first communication.

9. The non-transitory computer-readable medium of claim 8, wherein the permission level is assigned to the first communication by the sending device.

10. The non-transitory computer-readable medium of claim 9, wherein the permission level is assigned to the first communication by the third party server.

11. The non-transitory computer-readable medium of claim 10, wherein the third party server assigns a permission level based on content of the first communication.

12. The non-transitory computer-readable medium of claim 7, wherein the third party server is selected from the group consisting of: an access control server, a data loss prevention system, and a document management system.

13. A system, comprising:
a processor configured to:
compose a first communication addressed to one or more receivers;
generate a first communication key;
encrypt the first communication using the first communication key;
generate at least one key-encrypting key for each of the at least one receivers, wherein the at least one key-encrypting key is derived according to a key agreement protocol using ephemeral information from the sender and a third party server;
encrypt the first communication key with the at least one key-encrypting key;
encrypt the encrypted first communication key with a device key associated with a first receiver to produce a twice-encrypted communication key;
encapsulate the encrypted first communication and the twice-encrypted first communication key in a secure communication container; and
transmit the secure communication container to the one or more receivers; and
a memory coupled to the processor and configured to provide the processor with instructions.

14. A method comprising:
receiving, at a receiving device, a secure communication container from a sender, wherein the secure communication includes at least a first encrypted communication and a twice-encrypted first communication key;
decrypting, at the receiving device, the twice-encrypted first communication key with a first device key;
deriving, by the receiving device, a first key-encrypting key, wherein the first key-encrypting key is derived according to a key agreement protocol using ephemeral information from the sender and a third party server;
determining whether the receiving device is capable of decrypting the encrypted first communication key with the derived first key-encrypting key;
in response to determining that the receiving device is capable of decrypting the encrypted first communication key, decrypting the encrypted first communication key with the derived first key-encrypting key;
decrypting, at the receiving device, the first encrypted communication using the decrypted first communication key; and
providing the decrypted first communication to the receiver.

15. The method of 14, wherein the further comprising:
discarding the first encrypted communication when the receiving device determines that it is unable to decrypt the encrypted first communication key with the derived first key-encrypting key.

16. The method of claim 14, wherein the third party server is selected from the group consisting of: an access control server, a data loss prevention system, and a document management system.

17. The method of claim 14, wherein the first communication is selected from the group consisting of: a text message, a multimedia message, a telecommunication, a secure file transfer, and an audio recording.

18. The method of claim 14, wherein the ephemeral information from the third party server is based on a permission level associated with the receiving device.
